(19) United States
(12) Patent Application Publication
(10) Pub. No.: US 2020/0331132 A1
(43) Pub. Date: Oct. 22, 2020

(54) CYLINDER DEVICE

(71) Applicant: BASSO INDUSTRY CORP., Taichung (TW)

(72) Inventor: Chien-Kuo PO, Taichung (TW)

(73) Assignee: BASSO INDUSTRY CORP., Taichung (TW)

(21) Appl. No.: 16/850,790

(22) Filed: Apr. 16, 2020

(30) Foreign Application Priority Data
Apr. 19, 2019 (TW) 108113847

(51) Int. Cl. B25C 1/04

(52) U.S. Cl. CPC B25C 1/047

(57) ABSTRACT

A cylinder device includes a base seat including a coupling portion that surrounds an axis, and a cylinder unit having a coupling segment that is inserted into an internal space of the coupling portion. The coupling portion has alternately arranged first protrusion parts and first intermediate parts formed on an inner surface thereof, and the coupling segment has alternately arranged second protrusion parts and second intermediate parts formed on an outer surface thereof. The coupling segment is rotatable about the axis from a locked position, where the second protrusion parts respectively engage the first protrusion parts, to an locked position, where the second protrusion parts respectively align with the first intermediate parts.

### CROSS-REFERENCE TO RELATED APPLICATION

This application claims priority of Taiwanese Invention Patent Application No. 108113847, filed on Apr. 19, 2019.

### FIELD

The disclosure relates to a cylinder device, more particularly to a cylinder device installed in a nailing tool.

### BACKGROUND

A pneumatic nailing tool includes a conventional cylinder for storing gas. However, for a cylinder that must be installed in a specific direction, in order to ensure that the installation direction is correct and to satisfy a strength requirement, the conventional cylinder is provided in multiple portions and assembled using screws or rivets, which makes the process of assembly complicated and time consuming, and also increases the cost of manufacturing the conventional cylinder.

Moreover, a process, such as drilling, milling, cutting, etc., is used to form holes on the conventional cylinder, which also complicates the manufacturing process and increases manufacturing time.

### SUMMARY

Therefore, the object of the disclosure is to provide a cylinder device that can alleviate the drawbacks of the aforementioned prior art.

According to the disclosure, a cylinder device includes a base seat and a cylinder unit.

The base seat includes a coupling portion surrounding an axis and defining an internal space. The internal space has an open end and extends from the open end along the axis. The coupling portion has a coupling end, an inner surface, at least two first protrusion parts, and at least two first intermediate parts.

The coupling end is adjacent to the open end of the internal space. The inner surface surrounds the axis and extends from the coupling end along the axis. The first protrusion parts are angularly spaced apart from each other, protrude inwardly from the inner surface and are adjacent to the coupling end. The first intermediate parts are formed on the inner surface and are arranged alternately with the first protrusion parts.

The cylinder unit includes a cylinder body surrounding the axis and defining a cylinder chamber. The cylinder body has a coupling segment inserted through the open end of the internal space into the internal space, and having an outer surface, at least two second protrusion parts, and at least two second intermediate parts.

The outer surface surrounds the axis and confronts the inner surface of the coupling portion of the base seat. The second protrusion parts are angularly spaced apart from each other and protrude outwardly from the outer surface. The second intermediate parts are formed on the outer surface and arranged alternately with the second protrusion parts.

The coupling segment of the cylinder body is rotatable about the axis relative to the base seat from a locked position, where the second protrusion parts respectively engage the first protrusion parts of the coupling portion of the base seat and where each of the second intermediate parts cooperates with a respective one of the first intermediate parts of the coupling portion of the base seat to form a gap which is adapted for gas in the cylinder chamber to exit therethrough, to an unlocked position, where the second protrusion parts are respectively aligned with the first intermediate parts of the coupling portion of the base seat in a direction of the axis, and where the second intermediate parts are respectively aligned with the first protrusion parts of the coupling portion of the base seat in the direction of the axis, thereby permitting the cylinder unit to move along the axis relative to the base seat to be separated from the base seat.

### BRIEF DESCRIPTION OF THE DRAWINGS

Other features and advantages of the disclosure will become apparent in the following detailed description of the embodiment with reference to the accompanying drawings, of which:

FIG. 1 is an exploded perspective view of an embodiment of a cylinder device according to the disclosure;

FIG. 2 is a side view of the embodiment;

FIG. 3 is a sectional view taken along line III-III in FIG. 2, illustrating a coupling segment of a cylinder body the embodiment at a locked position;

FIG. 4 is a view similar to FIG. 3 but illustrating the coupling segment of the cylinder body at an unlocked position; and

FIG. 5 is a sectional view taken along line V-V in FIG. 2.

### DETAILED DESCRIPTION

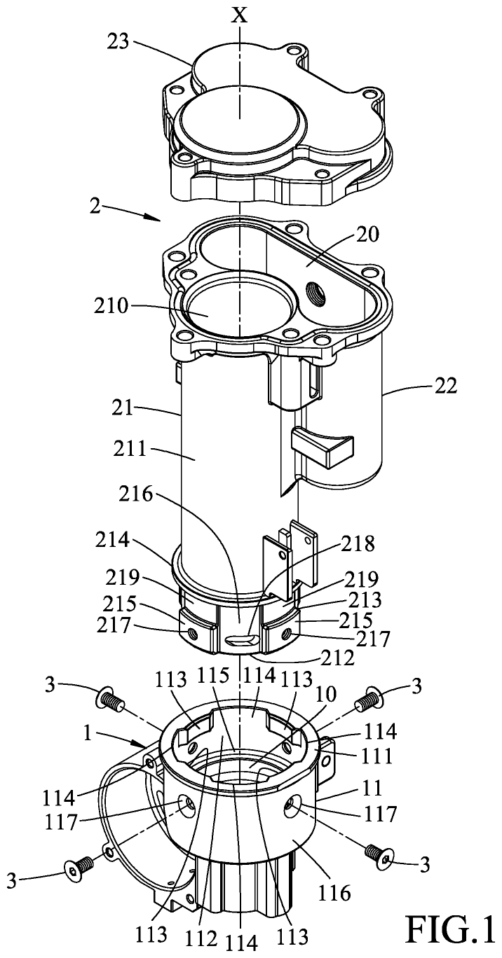

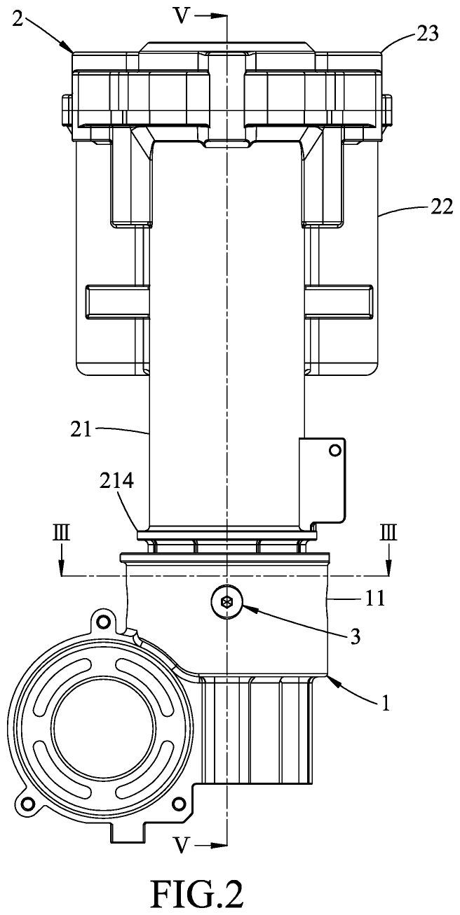

Referring to FIGS. 1 and 2, an embodiment of the cylinder device according to the disclosure is adapted to be installed on a nailing tool (not shown). The cylinder device includes a base seat 1, a cylinder unit 2, and at least one fastening member 3.

The base seat 1 includes a coupling portion 11 surrounding an axis (X) and defining an internal space 10. The internal space 10 has an open end and extends from the open end along the axis (X). The coupling portion 11 has a coupling end 111 adjacent to the open end of the internal space 10, an inner surface 112 surrounding the axis (X) and extending from the coupling end 111 along the axis (X), at least two first protrusion parts 113, at least two first intermediate parts 114, an internal ring-shaped projection 115, an outer surface 116 surrounding the inner surface 112, and at least one through hole 117 extending through the inner and outer surfaces 112, 116. The first protrusion parts 113 are angularly spaced apart from each other, protrude inwardly from the inner surface 112 and are adjacent to the coupling end 111. The first intermediate parts 114 are formed on the inner surface 112 and are arranged alternately with the first protrusion parts 113. The internal ring-shaped projection 115 extends inwardly from the inner surface 112 and is spaced apart from the first protrusion parts 113 along the axis (X).

In this embodiment, the at least two first protrusion parts 113 includes four first protrusion parts 113, and the at least two first intermediate parts 114 includes four first intermediate parts 114.

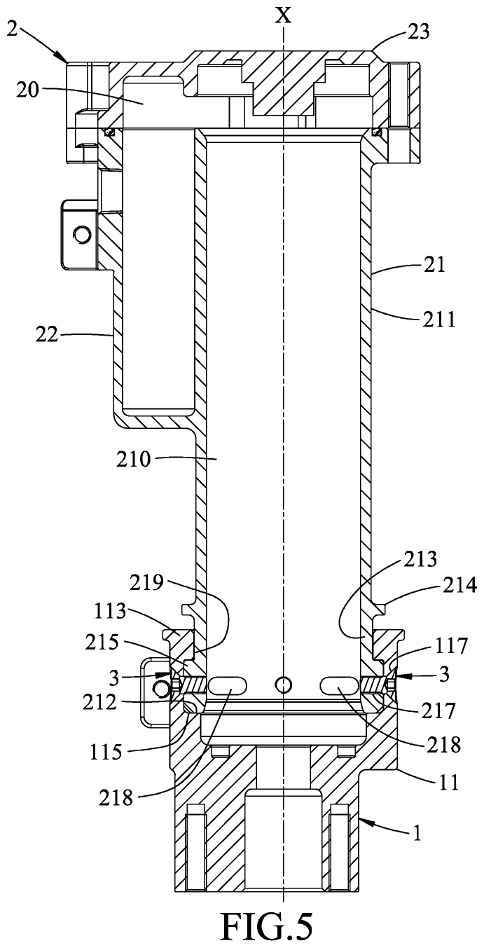

The cylinder unit 2 includes a striking cylinder 21 including a cylinder body 211 that has an open end, a storage member 22 connected to the cylinder body 211 of the striking cylinder 21 and having an open end, and a cap member 23 coupled to the storage member 22 and the cylinder body 211 of the striking cylinder 21. The open ends of the cylinder body 211 and the storage member 22 cooperate with the cap member 23 to define an air space 20 (see FIG. 5) that is in spatial communication with the cylinder chamber 210.

The cylinder body 211 surrounds the axis (X), defines a cylinder chamber 210, and further has a coupling segment 213 and an external ring-shaped projection 214. The coupling segment 213 extends from an end 212 of the cylinder body 211 along the axis (X), and the external ring-shaped projection 214 is spaced apart from the end 212 of the cylinder body 211 along the axis (X).

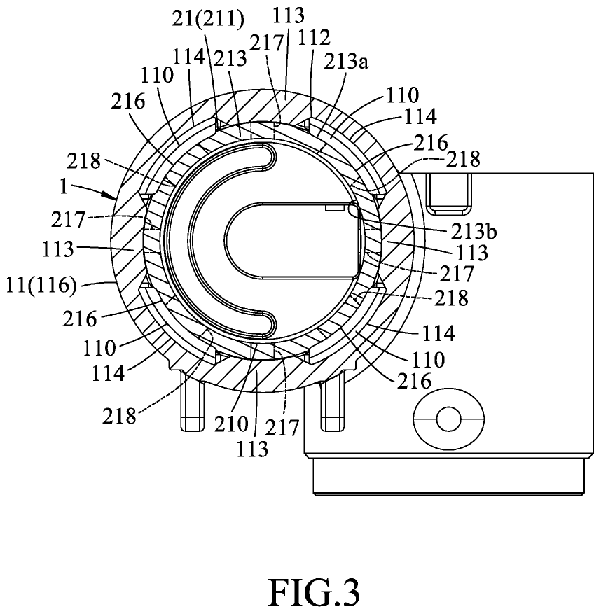

The coupling segment 213 is defined between the end 212 of the cylinder body 211 and the external ring-shaped projection 214, and is inserted through the open end of the internal space 10 into the internal space 10 of the base seat 1. Referring further to FIG. 3, the coupling segment 213 has an outer surface 213a surrounding the axis (X) and confronting the inner surface 112 of the coupling portion 11 of the base seat 1, an inner surface 213b surrounded by the outer surface 213a, at least two second protrusion parts 215, at least two second intermediate parts 216, at least one securing hole 217, and at least two gas outlet holes 218 extending through the inner and outer surfaces 213b, 213a. In this embodiment, the at least two second protrusion parts 215 includes four second protrusion parts 215, the at least two second intermediate parts 216 includes four second intermediate parts, and the at least one securing hole 217 includes four securing holes 217.

The second protrusion parts 215 are angularly spaced apart from each other and protrude outwardly from the outer surface 213a. The second intermediate parts 216 are formed on the outer surface 213a and arranged alternately with the second protrusion parts 215. In this embodiment, the second protrusion parts 215 are disposed at the end 212 of the cylinder body 211, and the second intermediate parts 216 extend from the end 212 of the cylinder body 211 in the direction of the axis (X). In this embodiment, the securing holes 217 extend respectively through the second protrusion parts 215 toward the inner surface 213b.

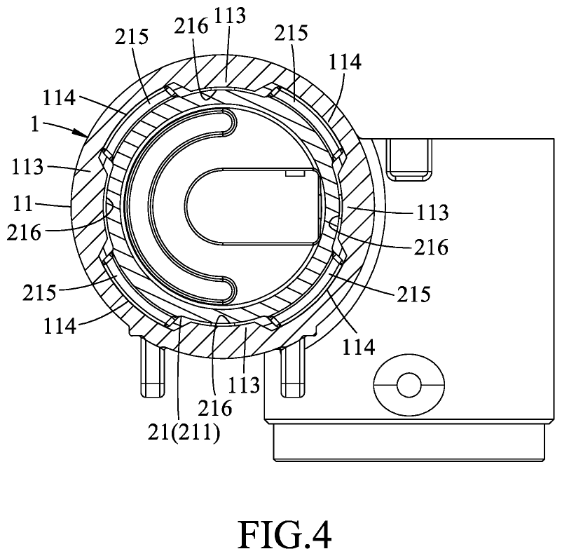

The coupling segment 213 of the cylinder body 211 is rotatable about the axis (X) relative to the base seat 1 from a locked position (see FIGS. 3 and 5) to an unlocked position (see FIG. 4). When the coupling segment 213 is at the locked position, the second protrusion parts 215 respectively engage the first protrusion parts 113 of the coupling portion 11 of the base seat 1, and each of the second intermediate parts 216 cooperates with a respective one of the first intermediate parts 114 of the coupling portion 11 of the base seat 1 to form a gap 110 which is adapted for gas in the cylinder chamber 210 to exit therethrough. Each of the gas outlet holes 218 communicates the cylinder chamber 210 and a corresponding one of the gaps 110. When the coupling segment 213 is at the unlocked position, the second protrusion parts 215 are respectively aligned with the first intermediate parts 114 of the coupling portion 11 of the base seat 1 in a direction of the axis (X), and the second intermediate parts 216 are respectively aligned with the first protrusion parts 113 of the coupling portion 11 of the base seat 1 in the direction of the axis (X), thereby permitting the cylinder unit 2 to move along the axis (X) relative to the base seat 1 to be separated from the base seat 1.

Each of the second protrusion parts 215 of the coupling segment 213 of the cylinder body 211 is disposed between the internal ring-shaped projection 115 and a respective one of the first protrusion parts 113 when the coupling segment 213 is at the locked position. Each of the second protrusion parts 215 cooperates with the external ring-shaped projection 214 to define an engaging groove 219 which receives a respective one of the first protrusion parts 113 of the coupling portion 11 of the base seat 1 when the coupling segment 213 is at the locked position.

In this embodiment, the at least two gas outlet holes 218 includes four gas outlet holes 218.

The storage member 22 is for storing a gas having a predetermined pressure.

The at least one fastening member 3 extends through the at least one through hole 117 and into the at least one securing hole 217 to lock the coupling segment 213 of the cylinder body 211 at the locked position.

In this embodiment, the quantities of the fastening member 3, the through hole 117 and the securing hole 217 are four, the fastening members 3 are screws, and the securing holes 217 are threaded holes. In other embodiments, for example, the fastening members 3 may be plugs and the securing holes 217 may be jacks. In other embodiments, the quantities of the fastening member 3, the through hole 117 and the securing hole 217 may be two.

Referring to FIGS. 3 to 5, to assemble the cylinder device, first the second protrusions parts 215 of the coupling segment 213 of the cylinder body 211 are respectively aligned with the first intermediate parts 114 of the coupling portion 11 of the base seat 1 in the direction of the axis (X). Then, the cylinder body 211 is inserted into the internal space 10 of the base seat 1 so that the coupling segment 213 of the cylinder body 211 is at the unlocked position. Finally, the cylinder body 211 is rotated about the axis (X) until the coupling segment 213 is moved to the locked position. Finally, the fastening members 3 are respectively inserted through the through holes 117 to respectively engage the securing holes 217 to lock the coupling segment 213 of the cylinder body 211 at the locked position.

The cylinder device is adapted to be used with a piston unit (not shown) installed in the cylinder chamber 210. The gas having a predetermined pressure stored in the storage member 22 can flow into the cylinder chamber 210 through the air space 20 to drive the piston unit to move along the axis (X) in a direction from the cap member 23 toward the base seat 1. During this movement of the piston unit toward the base seat 1, a volume of a space defined between the piston unit and the base seat 1 is reduced and gas stored in said space may be discharged through the gas outlet holes 218 and the gaps 110 to the outside environment instead of being compressed. This reduces resistance experienced by the piston unit as it moved toward the base seat 1.

In variations of the embodiment, the gas outlet holes 218 maybe omitted and the gas stored in said space may flow into the gaps 110 through a gap between the end 212 of the cylinder body 211 and the internal ring-shaped projection 115.

The benefits of the cylinder device of the disclosure is as follows:

1. By provision of the first and second protrusion parts 113, 215 and the first and second intermediate parts 114, 216, the cylinder body 211 and the base seat 1 may be easily coupled with each other, and the gaps 110 are formed between the first and second intermediate parts 114, 216. This simplifies the structure of the cylinder device and increases convenience of assembly.

2. The first and second protrusion parts 113, 215 help strengthen structural integrity of the coupling portion 11 of the base seat 1 and the coupling segment 213 of the cylinder body 211.

In the description above, for the purposes of explanation, numerous specific details have been set forth in order to provide a thorough understanding of the embodiment. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A cylinder device, comprising:
a base seat including a coupling portion that surrounds an axis and that defines an internal space, said internal space having an open end and extending from said open end along the axis, said coupling portion having
a coupling end that is adjacent to said open end of said internal space,
an inner surface that surrounds the axis and that extends from said coupling end along the axis,
at least two first protrusion parts that are angularly spaced apart from each other, that protrude inwardly from said inner surface and that are adjacent to said coupling end, and
at least two first intermediate parts that are formed on said inner surface and that are arranged alternately with said first protrusion parts; and
a cylinder unit including a cylinder body that surrounds the axis and that defines a cylinder chamber, said cylinder body having a coupling segment that is inserted through said open end of said internal space into said internal space, and that has
an outer surface surrounding the axis and confronting said inner surface of said coupling portion of said base seat,
at least two second protrusion parts being angularly spaced apart from each other and protruding outwardly from said outer surface, and
at least two second intermediate parts formed on said outer surface and arranged alternately with said second protrusion parts;
wherein said coupling segment of said cylinder body is rotatable about the axis relative to said base seat from a locked position, where said second protrusion parts respectively engage said first protrusion parts of said coupling portion of said base seat and where each of said second intermediate parts cooperates with a respective one of said first intermediate parts of said coupling portion of said base seat to form a gap which is adapted for gas in said cylinder chamber to exit therethrough, to an unlocked position, where said second protrusion parts are respectively aligned with said first intermediate parts of said coupling portion of said base seat in a direction of the axis, and where said second intermediate parts are respectively aligned with said first protrusion parts of said coupling portion of said base seat in the direction of the axis, thereby permitting said cylinder unit to move along the axis relative to said base seat to be separated from said base seat.

2. The cylinder device as claimed in claim 1, wherein:
said coupling segment of said cylinder body extends from an end of said cylinder body along the axis; and
said second protrusion parts of said coupling segment are disposed at said end of said cylinder body.

3. The cylinder device as claimed in claim 2, wherein:
said cylinder body further has an external ring-shaped projection spaced apart from said end of said cylinder body along the axis;
said coupling segment of said cylinder body is defined between said end of said cylinder body and said external ring-shaped projection; and
each of said second protrusion parts of said coupling segment of said cylinder body cooperates with said external ring-shaped projection to define an engaging groove which receives a respective one of said first protrusion parts of said coupling portion of said base seat when said coupling segment is at the locked position.

4. The cylinder device as claimed in claim 3, wherein said coupling portion of said base seat further has an internal ring-shaped projection extending inwardly from said inner surface and spaced apart from said first protrusion parts along the axis, each of said second protrusion parts of said coupling segment of said cylinder body being disposed between said internal ring-shaped projection and a respective one of said first protrusion parts when said coupling segment is at the locked position.

5. The cylinder device as claimed in claim 2, wherein said second intermediate parts of said coupling segment of said cylinder body extend from said end of said cylinder body in the direction of the axis.

6. The cylinder device as claimed in claim 1, wherein said coupling segment of said cylinder body further has an inner surface surrounded by said outer surface of said coupling segment, and at least two gas outlet holes extending through said inner and outer surfaces of said coupling segment, each of said gas outlet holes communicating said cylinder chamber and a corresponding one of said gaps.

7. The cylinder device as claimed in claim 1 further comprising at least one fastening member, wherein:
said coupling portion of said base seat further has an outer surface surrounding said inner surface, and at least one through hole extending through said inner and outer surfaces; and
said coupling segment of said cylinder body further has an inner surface surrounded by said outer surface of said coupling segment, and at least one securing hole extending inwardly through one of said second protrusion parts and toward said inner surface; and
said at least one fastening member extends through said at least one through hole and into said at least one securing hole to lock said coupling segment of said cylinder body at the locked position.

8. The cylinder device as claimed in claim 7, wherein said at least one fastening member includes two fastening members, said at least one through hole includes two through holes, and said at least one securing hole includes two securing holes.

9. The cylinder device as claimed in claim 1, wherein:
said cylinder unit includes
a striking cylinder including said cylinder body, said cylinder body having an open end,
a storage member connected to said cylinder body of said striking cylinder and having an open end, and
a cap member coupled to said storage member and said cylinder body of said striking cylinder; and
said open ends of said cylinder body and said storage member cooperate with said cap member to define an air space that is in spatial communication with said cylinder chamber.
